(19) United States
(12) Patent Application Publication
(10) Pub. No.: US 2019/0343716 A1
(43) Pub. Date: Nov. 14, 2019

(54) Massage Assembly

(71) Applicant: Joycelyn M. Johnson-Kendrick, Montgomery, AL (US)

(72) Inventor: Joycelyn M. Johnson-Kendrick, Montgomery, AL (US)

(21) Appl. No.: 15/974,754

(22) Filed: May 9, 2018

(51) Int. Cl. A61H 23/02; A47K 13/30

(52) U.S. Cl. CPC A61H 23/0263; A47K 13/305; A61H 2015/005; A61H 2205/081; A61H 2023/0281

(57) ABSTRACT

A massage assembly for providing a massage while a user sits on a toilet includes a toilet that has a tank, a seat and a lid. A massage unit is attached to the toilet and the massage unit massages a user when the user sits on the lid.

### BACKGROUND OF THE DISCLOSURE

### Field of the Disclosure

The disclosure relates to massage devices and more particularly pertains to a new massage device for providing a massage while a user sits on a toilet.

### SUMMARY OF THE DISCLOSURE

An embodiment of the disclosure meets the needs presented above by generally comprising a toilet that has a tank, a seat and a lid. A massage unit is attached to the toilet and the massage unit massages a user when the user sits on the lid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a massage assembly according to an embodiment of the disclosure.

FIG. 2 is a perspective view of an alternative embodiment of the disclosure.

FIG. 3 is a front view of an embodiment of the disclosure.

FIG. 4 is a left side in-use view of an embodiment of the disclosure.

FIG. 5 is a front perspective view of an embodiment of the disclosure.

FIG. 6 is a schematic view of an embodiment of the disclosure.

FIG. 7 is a cross sectional view taken along line 7-7 of FIG. 1 of an embodiment of the disclosure.

FIG. 8 is a left side view of an alternative embodiment of the disclosure.

### DESCRIPTION OF THE PREFERRED EMBODIMENT

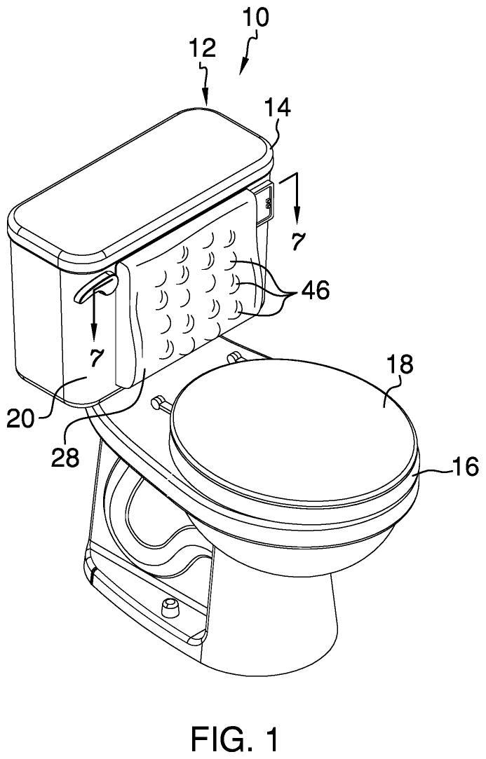

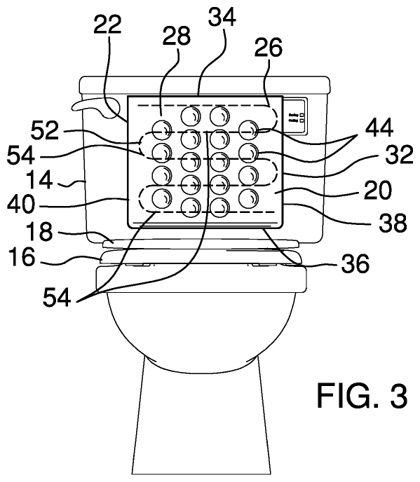

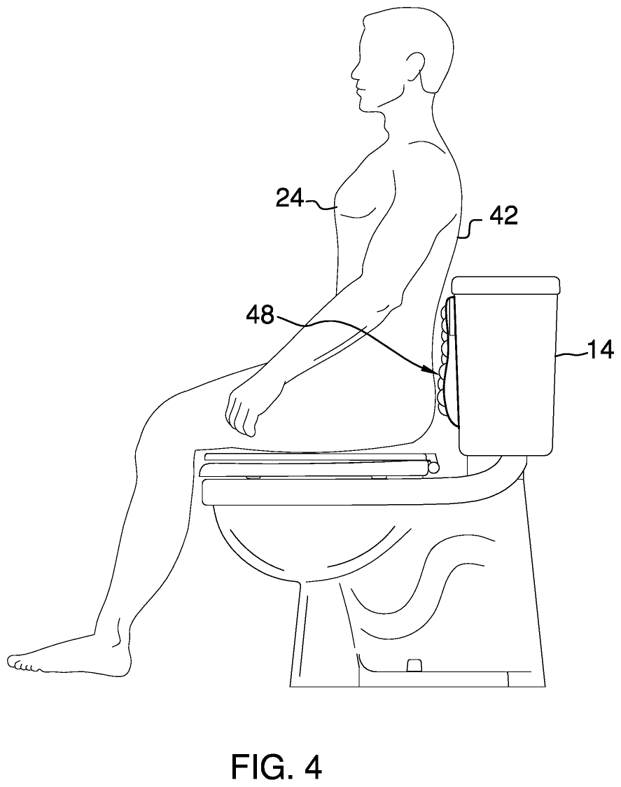

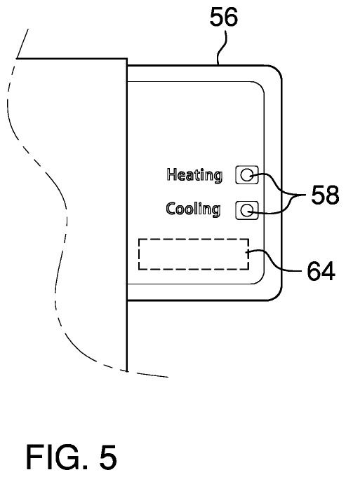

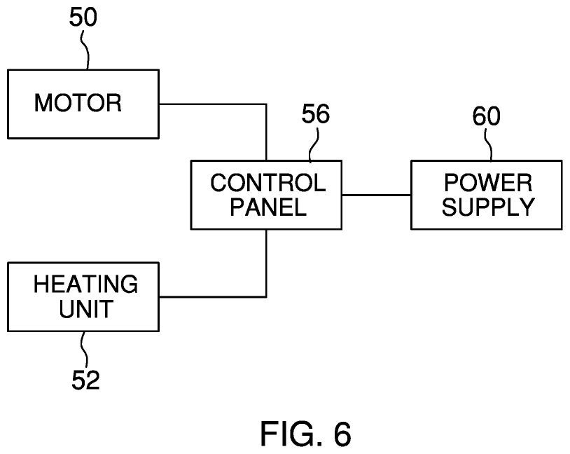

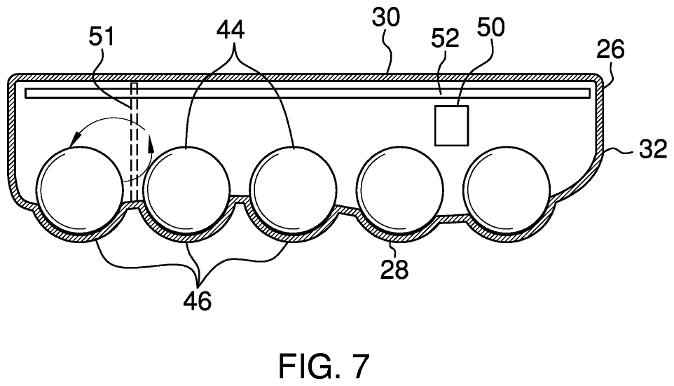

With reference now to the drawings, and in particular to FIGS. 1 through 8 thereof, a new massage device embodying the principles and concepts of an embodiment of the disclosure and generally designated by the reference numeral 10 will be described.

As best illustrated in FIGS. 1 through 8, the massage assembly 10 generally comprises a toilet 12 that has a tank 14, a seat 16 and a lid 18. The tank 14 has a forward side 20 facing the seat 16 and the toilet 12 may be a toilet of any conventional design. A massage unit 22 is attached to the toilet 12 thereby facilitating the massage unit 22 to massage a user 24 when the user 24 sits on the lid 18.

The massage unit 22 comprises a panel 26 that has a front side 28, a back side 30 and a perimeter edge 32 extending between the front side 28 and the back side 30. The perimeter edge 32 has a top side 34, a bottom side 36, a first lateral side 38 and a second lateral side 40. The back side 30 is attached to the forward side 20 of the tank. Thus, the front side 28 may have the user's back 42 pressed thereon when the user 24 sits on the lid 18 to utilize the toilet 12 in the convention of a chair.

A plurality of balls 44 is positioned between the front side 28 and the back side 30. The balls 44 are spaced apart from each other and distributed to substantially cover the panel 26. Each of the balls 44 urges the front side 28 forwardly from the back side 30 to define a plurality of raised bumps 46 on the front side 28. The panel 26 may be comprised of a deformable material such as vinyl. The front side 28 of the panel 26 may undulate between the top side 34 and the bottom side 36 to define a raised portion 48 of the panel 26 that is positioned adjacent to and is coextensive with the bottom side 30.

A motor 50 is positioned within the panel 26 and the motor 50 is mechanically coupled to each of the balls 40. The motor 50 urges each of the balls 40 to orbit around an axis 51 extending between the front side 28 and the back side 30 thereby facilitating each of the balls 44 to massage the user's back 42. The motor 50 may be an electrical motor or the like. The motor 50 may be mechanically coupled to each to the balls 44 through any conventional means, or the motor 50 may be one of a plurality of motors 50 that is each mechanically coupled to an associated one of the balls 44.

A heating unit 52 is positioned between the balls 44 and the back side 30. The heating unit 52 comprises a plurality of coils 54 extending between the first lateral side 38 and the second lateral side 40. The coils 54 are spaced apart from each other and distributed between top side 34 and the bottom side 36 and the heating unit 52 is in thermal communication with each of the balls 44. The heating unit 52 heats each of the balls 44 to transfer heat to the user's back 42. The heating unit 52 may have an operational temperature ranging between approximately 90° Fahrenheit and 110° Fahrenheit.

Cooling of the balls 44 is controlled and achieved by . . . . There are no conventional cooling systems we are aware of to specifically cool the balls 44 as you describe. We need to know how the balls 44 will be cooled.

A control panel 56 is attached to the panel 26 and the control panel 56 is positioned on the first lateral side 38 of the perimeter edge 32. The control panel 56 has a plurality of buttons 58 thereon and each of the buttons 58 is electrically coupled to at least one of the motor 50 and the heating unit 52. The heating unit 52 and the motor 50 are operable by manipulation of the buttons 58. A power supply 60 is attached to the control panel 56 and the power supply 60 is electrically coupled to the control panel 56. The power supply 60 may be electrically coupled to a power source 62. The power supply 60 may comprise a battery 64 such that the power supply 60 is self contained to minimize risks related to being positioned in a water and steam laden environment such as a bathroom.

The control panel 56 may be operated by manipulation of the buttons 58. Alternatively, a microphone (not yet shown) and voice control unit (not yet shown) may be coupled to or otherwise operationally incorporated into the control panel 56.

The cover protection setting and emergency alert settings are not described with enough detail to know exactly what the purpose is and how they interact with the other parts already in the application. I need more detail and explanation to include these features.

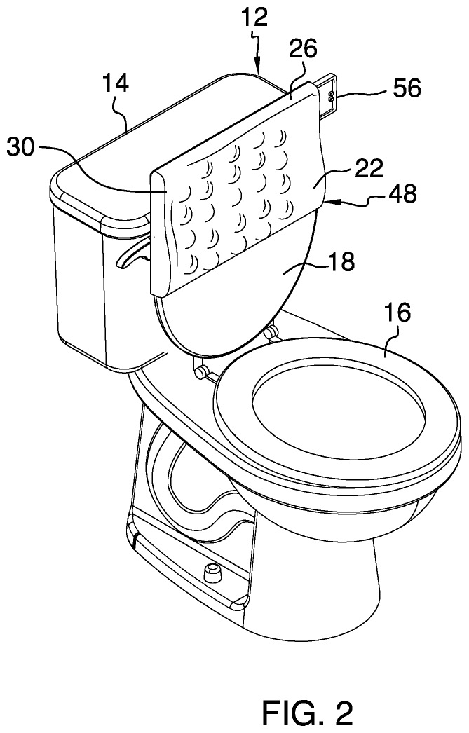

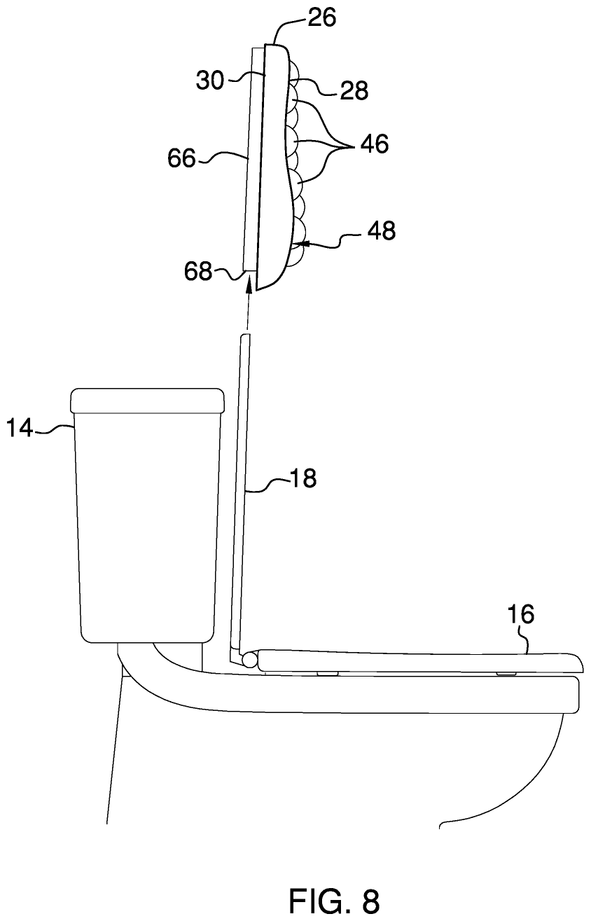

In an alternative embodiment 65 as shown in FIGS. 2 and 8, a pocket 66 may be attached to the back side 30 of the panel 26. The pocket has an open bottom end 68 and the lid 18 of the toilet 12 may be inserted into the open bottom end 68 of the pocket 66 when the lid 18 is positioned in an open position with respect to the seat 16. The front side 28 of the panel 26 may have the user's back 42 pressed thereon when the user 24 sits on the seat 16 to utilize the toilet 12 for defecation or urination.

A protective cover (not yet shown) may be provided. The protective cover is positionable to extend over the assembly 10 while the assembly 10 is not in use.

In use, the user 24 sits on the lid 18 to utilize the toilet 12 in the convention of a chair. Selected ones of the buttons 58 are engaged to activate the motor 50 and the heating unit 52. The user 24 presses the user's back 42 against the front side 28 of the panel 26. The user 24 may receive a massage with heat therapy, a massage without heat therapy or heat therapy without a massage. In the alternative embodiment 65 as shown in FIGS. 2 and 8, the user 24 positions the lid 18 in the open position and slips lid into the pocket 66. The user 24 may receive a massage with heat therapy, a massage without heat therapy or heat therapy without a massage while the user 24 utilizes the toilet 12 for the purposes of defecation or urination.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massage assembly comprising:
a toilet having a tank, a seat and a lid; and
a massage unit attached to said toilet, said massage unit being configured to massage a user when the user sits on said lid.

2. The assembly according to claim 1, wherein:
said tank has a forward side facing said seat; and
said massage unit comprises a panel having a front side, a back side and a perimeter edge extending between said front side and said back side, said perimeter edge having a top side, a bottom side, a first lateral side and a second lateral side, said back side being attached to said forward side of said tank wherein said front side is configured to have the user's back pressed thereon when the user sits on said lid.

3. The assembly according to claim 2, further comprising a plurality of balls positioned between said front side and said back side, said balls being spaced apart from each other and distributed to substantially cover said panel, each of said balls urging said front side forwardly from said back side to define a plurality of raised bumps on said front side.

4. The assembly according to claim 3, further comprising a motor positioned within said panel, said motor being mechanically coupled to each of said balls, said motor urging each of said balls to orbit around an axis extending between said front side and said back side, each of said balls being configured to massage the user's back.

5. The assembly according to claim 4, further comprising a heating unit positioned between said balls and said back side, said heating unit comprising a plurality of coils extending between said first lateral side and said second lateral side, said coils being spaced apart from each other and distributed between top side and said bottom side, said heating unit being in thermal communication with each of said balls, said heating unit heating each of said balls wherein said heating unit is configured to transfer heat to the user's back.

6. The assembly according to claim 1, further comprising:
a panel having a perimeter edge;
a motor;
a heating unit; and
a control panel attached to said panel, said control panel being positioned on said perimeter edge, said control panel having a plurality of buttons thereon, each of said buttons being electrically coupled to at least one of said motor and said heating unit wherein said heating unit and said motor are operable by manipulation of said buttons.

7. The assembly according to claim 6, wherein a power supply attached to said control panel, said power supply being electrically coupled to said control panel, said power supply being configured to be electrically coupled to a power source.

8. A massage assembly comprising:
a toilet having a tank, a seat and a lid, said tank having a forward side facing said seat; and
a massage unit attached to said toilet, said massage unit being configured to massage a user when the user sits on said lid, said massage unit comprising
a panel having a front side, a back side and a perimeter edge extending between said front side and said back side, said perimeter edge having a top side, a bottom side, a first lateral side and a second lateral side, said back side being attached to said front side of said tank wherein said front side is configured to have the user's back pressed thereon when the user sits on said lid,
a plurality of balls positioned between said front side and said back side, said balls being spaced apart from each other and distributed to substantially cover said panel, each of said balls urging said front side forwardly from said back side to define a plurality of raised bumps on said front side,
a motor positioned within said panel, said motor being mechanically coupled to each of said balls, said motor urging each of said balls to orbit around an axis extending between said front side and said back side, each of said balls being configured to massage the user's back,
a heating unit positioned between said balls and said back side, said heating unit comprising a plurality of coils extending between said first lateral side and said second lateral side, said coils being spaced apart from each other and distributed between top side and said bottom side, said heating unit being in thermal communication with each of said balls, said heating unit heating each of said balls wherein said heating unit is configured to transfer heat to the user's back,
a control panel attached to said panel, said control panel being positioned on said perimeter edge, said control panel having a plurality of buttons thereon, each of said buttons being electrically coupled to at least one of said motor and said heating unit wherein said heating unit and said motor are operable by manipulation of said buttons, and
a power supply attached to said control panel, said power supply being electrically coupled to said control panel, said power supply being configured to be electrically coupled to a power source.
